(19) United States
(12) Patent Application Publication
(10) Pub. No.: US 2026/0119282 A1
(43) Pub. Date: Apr. 30, 2026

(54) SYSTEMS AND METHODS USING AI AGENT TO CALL AN APPLICATION PROGRAMMING INTERFACE

(71) Applicant: Dell Products L.P., Round Rock, TX (US)

(72) Inventors: Suraj M Varma, Portland, OR (US); Marcus Daniel Molner, Austin, TX (US); Kai Wang, Shanghai (CN)

(73) Assignee: Dell Products L.P., Round Rock, TX (US)

(21) Appl. No.: 18/931,435

(22) Filed: Oct. 30, 2024

(51) Int. Cl. G06F 9/54; G06F 40/20

(52) U.S. Cl. CPC G06F 9/54; G06F 40/20

(57) ABSTRACT

A computer system may include an artificial intelligence (AI) agent that is configured to receive natural language input and to provide text data output that is configured to select one or more application programming interfaces (APIs). A user may interact with the computer system by providing natural language input representing a task to be completed, and the AI agent may determine one or more appropriate APIs, call those APIs, and indicate completion of the task to the user.

### FIELD

This disclosure relates generally to Information Handling Systems (IHSs), and more specifically, to systems and methods for determining and calling one or more application programming interfaces (APIs) via an artificial intelligence agent.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

According to an embodiment, a method includes: receiving natural language input from a human user to an artificial intelligence (AI) agent, wherein the natural language input indicates a task; outputting text data from the AI agent in response to receiving the natural language input; determining a first application programming interface (API) corresponding to the text data; calling the first API; and reporting completion of the task in response to performing a function of the first API.

According to an embodiment, Information Handling System (IHS), includes: a processor; and a memory coupled to the processor, the memory having program instructions stored thereon that, upon execution by the processor, cause the IHS to: receive a natural language request from a human user to perform a task; translate the natural language request into output data configured to match with descriptions of a plurality of application programming interfaces (APIs); determine a first API of the plurality of APIs, according to the output data; call the first API, thereby causing an action on an IHS of the human user; and report the action to the human user on a graphical user interface (GUI) of the human user.

According to an embodiment, a hardware memory device has program instructions stored thereon that, upon execution by a processor of an IHS, causes the IHS to: receive a natural language request from a human user to perform a task; translate the natural language request into text data that is configured to match with descriptions of a plurality of application programming interfaces (APIs) of a database of APIs; search the database, according to the text data, to determine a first API of the plurality of APIs; call the first API, thereby causing an action on an IHS of the human user; and report the action to the human user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of components of an example Information Handling System (IHS), according to some embodiments.

FIG. 2 is an illustration of an example software arrangement, which may be implemented on an IHS, such as the IHS of FIG. 1, according to some embodiments.

FIG. 3 is an illustration of an example software arrangement, which may be implemented on an IHS, such as the IHS of FIG. 1, according to some embodiments.

FIG. 4 is an illustration of an example method, for selecting one or more APIs through natural language input, according to some implementations.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. It should be appreciated that although certain embodiments are discussed in the context of a personal computing device, other embodiments may utilize various other types of IHSs.

Various embodiments include systems and methods that provide assistance to a human user through an artificial intelligence (AI) agent. The agent may be configured to receive natural language requests from a user, where a natural language request may be for the AI agent to perform an action on an IHS of the user. For instance, the user may desire to change an audio setting. The human user may make a natural language request, such as “change audio input from array microphone to headset microphone.”

The AI agent is configured to receive that request and to translate the request into data that may be used to select one or more application programming interfaces (APIs) from a multitude of APIs. For instance, the APIs may be listed in a database or other data structure, where each API corresponds to one or multiple descriptor words. The AI agent may be configured to translate the natural language request into text data that is expected to match descriptor words for one or more APIs. The AI agent may include functionality to search the data structure, including searching by descriptor words, using the text data that was generated from the natural language input. In an example, the AI agent may determine that a particular API is a best match to the AI agent output.

The AI agent may further be configured to call the API, thereby performing a function. Continuing with the example above, the API may include a function to switch from one microphone to another microphone. After having called the API, the AI agent may then report completion of the task to the human user.

In one example, the report to the human user may include an option for the human user to provide feedback, such as indicating that the AI agent performed the task correctly or that the AI agent did not perform the task correctly. Such feedback may be used to further configure or train the AI agent.

In one example, the request may correspond to multiple actions to be performed and may, thus, correspond to multiple APIs to be called. The AI agent may be configured to identify actions to complete the task, determine an order of the actions to achieve completion of the task, generate text data to correspond to the plurality of actions, use that text data to identify a plurality of APIs to call, and then call the plurality of APIs in the order of the plurality of actions.

The example above illustrates a use case in which a user desires to interact with the user's own IHS. In other words, there may be a multitude of APIs used by the IHS, such as may be associated with an operating system of the IHS, applications installed on the IHS, and the like. The AI agent may be configured to select from among those APIs.

In another example, the AI agent may be configured to request and receive generated content from one or more network-based content creation tools. Network-based tools, such as web-based AI content creator applications, may publish APIs for use by subscribers. The AI agent may be configured to translate the natural language input into output data that may be used to select from APIs associated with network-based content creation tools. In one example, a user may provide a natural language request to the AI agent, such as “get a picture of a cat in the snow and paste it into my slideshow.” The AI agent may be configured to determine a type of content to be created, generate text data configured to select an API from an appropriate content creation tool, generate a prompt for the content creation tool, call the API, receive the requested content from the creation tool, identify an appropriate API to paste the content into the slideshow, call that API to result in pasting the content to the slideshow, and report completion of the task to the user. Once again, the user may be provided with an option to indicate a good result or a bad result, and that feedback may be used to further train the AI agent.

Various embodiments may include advantages over prior solutions. For instance, prior solutions may focus on providing instructions to a user in response to a natural language request. Using the example above, if the user requests to change an audio input from one microphone to another microphone, a prior solution may determine steps for the user to take and then provide the results to the user as a set of instructions for the user to perform manually. For instance, the set of instructions may indicate to the user to go through multiple menus to arrive at an option to change the microphone.

By contrast, various embodiments described herein may carry out an action on behalf of the user by selecting appropriate APIs based on the natural language input. The AI agent may then call the selected APIs, thereby resulting in actions performed. In other words, one advantage may include more efficient use of the IHS, by taking a shorter amount of time to get to a desired result on behalf of the user. Another advantage may include increased satisfaction by the human user because the human user may be saved time and effort.

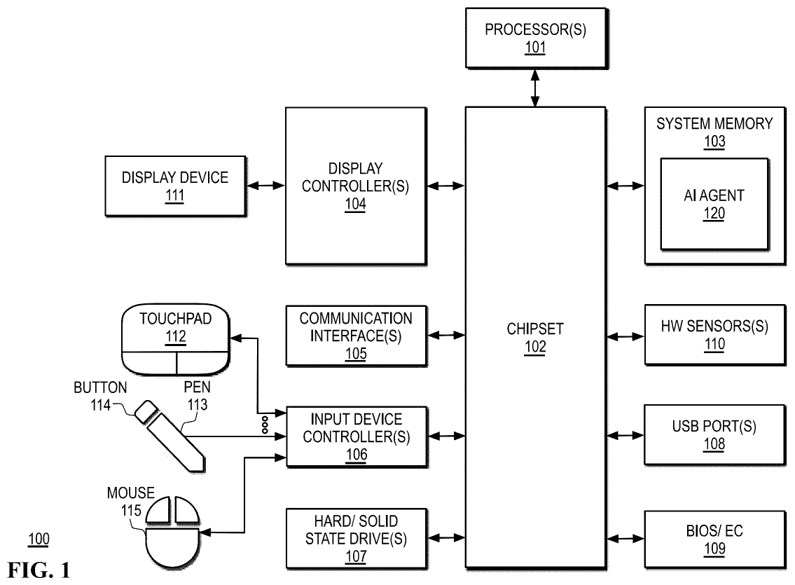

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BLUETOOTH, cellular or mobile networks (e.g., CDMA, TDMA, LTE, etc.), satellite networks, or the like. In some cases, communication interface(s) 105 may be coupled to chipset 102 via a PCIe bus.

Chipset 102 may be coupled to display controller(s) 104, which may include one or more or graphics processor(s) (GPUs) on a graphics bus, such as an Accelerated Graphics Port (AGP) or Peripheral Component Interconnect Express (PCIe) bus. As shown, display controller(s) 104 provide video or display signals to display device 111. In other implementations, any number of display controller or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays. In some embodiments, display device 111 may be utilized to provide interactive visual output, such as on a graphical user interface (GUI), for a human user.

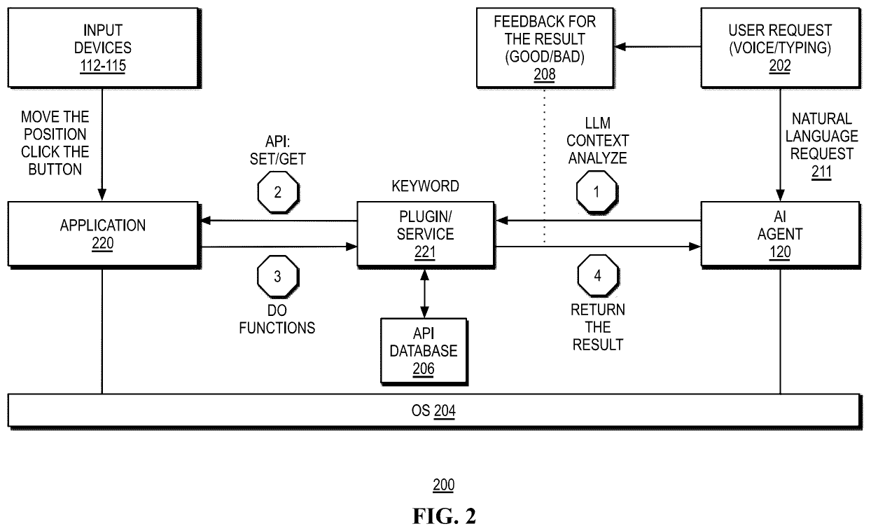

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. Memory 103 may store program instructions that, upon execution by processor 101, perform functionality of an application. In the example of FIG. 1, memory 103 includes program instructions that, when executed, provide functionality of artificial intelligence (AI) agent 120. AI agent 120 may be configured to receive natural language input and to cause an API to be called based on that natural language input. AI agent 120 is described in more detail with respect to FIGS. 2-4.

Chipset 102 may also provide access to one or more hard disk and/or solid-state drives 107. In certain embodiments, chipset 102 may also provide access to one or more optical drives or other removable-media drives. In certain embodiments, chipset 102 may also provide access to one or more Universal Serial Bus (USB) ports 108.

Chipset 102 may further provide access to input device controllers 106, for example, a super I/O controller, firmware or software functionality, or the like. Examples of user input devices which may be communicatively coupled to input device controllers 106 include, but are not limited to, a keyboard, mouse 115, touchpad 112, stylus or pen 113 (with button or switch 114), totem, etc. Input device controllers 106 may represent multiple controllers, such that each of the user input devices may correspond to a respective controller (e.g., a touchpad may have its own touchpad controller). Each of the input devices may interface with its respective controller 106 through a wired or wireless connection (e.g., via communication interfaces(s) 105).

In certain embodiments, chipset 102 may also provide an interface for communications with one or more hardware sensors 110. Sensors 110 may be disposed on or within the chassis of IHS 100, and may include, but are not limited to: electric, magnetic, radio, optical, infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. The BIOS provides an abstraction layer that allows the OS to interface with certain hardware components that are utilized by IHS 100. Via the hardware abstraction layer provided by the BIOS, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

EC 109 may also implement operations for detecting certain changes to the physical configuration or posture of IHS 100 and managing the modes of a touchpad or other user input device 106 in different configurations of IHS 100. For instance, where IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip. As such, in certain embodiments, IHS 100 may be implemented as different classes of computing devices including, but not limited to: servers, workstations, desktops, laptops, appliances, video game consoles, tablets, smartphones, etc.

FIG. 2 is an illustration of an example software arrangement 200, which may be implemented on an IHS, such as IHS 100 of FIG. 1, according to some embodiments. For instance, the operating system 204 may include program instructions, which are executed by the processors 101. The AI agent 120, the application 220, and the plug-in service 221 may also include program instructions, which are executed by the processors 101. Further, in the example of FIG. 2, the plug-in service 221 is shown as being separate from the AI agent 120, though the scope of embodiments is not so limited. Rather, the AI agent 120 and the plug-in service 221 may be considered a same application in some instances, where that combined application of the AI agent 120 and the plug-in service 221 operate to receive natural language in the form of a request 221 and to call an API in response to the natural language request 211.

In the present example, the AI agent 120 is shown as being implemented as a large language model (LLM), and the scope of implementations may include any appropriate AI application. Application 220 may be any application that a user may run on the IHS. Examples of applications may include word processor applications, drawing applications, conferencing applications, spreadsheet applications, IHS-specific settings and configuration applications, AI-based support applications, web browsers, and/or the like.

In one example use case, a user may use her voice to make a natural language request 211 such as by voice or typing, at action 202. The AI agent 120 receives the natural language request 211. The AI agent 120 may be configured so that at Action 1 it may generate output data, such as text data, which may be used to match API descriptions in API database 206.

An example natural language request 211 may include something like, “my computer is running hot, please help.” The AI agent 120 may receive that natural language request 211 and generate output text data at Action 1. The AI agent 120 may be configured so that its output may be expected to approximately match at least some descriptors of APIs in the API database 206. In one example, the API database 206 may include a listing of APIs, with each API being associated with one or more text descriptors. The AI agent 120 may output text data, such as having example keywords, “fan,” “power,” “temperature,” “speed,” and/or the like. The plug-in service 221 may receive the text output from the AI agent 120 and may perform a search of the API database 206 using the text data from AI agent 120 as one or more keys to match to text descriptors of the APIs. For instance, the plug-in service 221 may search the API database 206 and determine that a best match includes a first API with the text descriptors “fan speed” and a second API with a text descriptor “motherboard temperature.”

The plug-in service 221 (which may be considered part of AI agent 120) may then determine to select the first API and the second API. For instance, the plug-in service 221 may make a set call at Action 2 for the first API, causing the fan speed of the IHS to increase. In the present example, the application 220 may represent a configuration or settings application, and the plug-in service 221 may make the set call to the application 220. The function of the first API may be to either reduce or increase the fan speed.

Similarly, the plug-in service 221 may make a get call at Action 2 for the second API. The function of the second API may be to cause the application 220 to return a reading of the motherboard temperature.

At Action 3, the application 220 returns a confirmation to the plug-in service 221 that the API calls have been made. At Action 4, the plug-in service 221 returns the results to the AI agent 120. The AI agent 120 may further be configured to generate text data for the human user to report the results. For instance, the AI agent 120 may provide a message on a GUI stating, “the fan speed of your computer has been increased, and the current motherboard temperature reading is 65° C.”

Furthermore, the AI agent 120 may provide an indication for the user to give feedback 208. For instance, the AI agent 120 may generate a natural language prompt for the user, such as “are you satisfied with the completion of the task?” The AI agent 120 may also generate a graphical button or other tool for the user to indicate either satisfaction or dissatisfaction and to provide further feedback 208. The AI agent 120 may receive the feedback 208 and, if appropriate, train further or update based on the feedback 208.

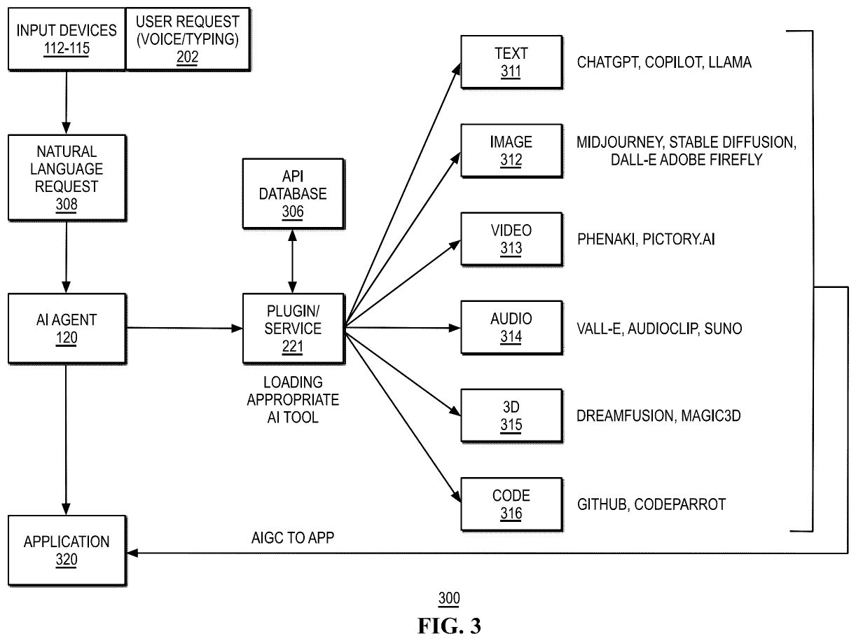

FIG. 3 is an illustration of an example software arrangement 300, which may be implemented on an IHS, such as IHS 100 of FIG. 1, according to some embodiments. The software arrangement 300 of FIG. 3 may be used with the software arrangement 200 of FIG. 2; i.e., the software arrangements 200 and 300 are not mutually exclusive.

API database 306 includes a multitude of entries, each of the entries corresponding to an API and having text descriptors, as in API database 206. However, API database 306 has been adapted to include both IHS-specific APIs as well as APIs associated with network-based content creation tools. For instance, various content creation tools that are accessible on the Internet or on the World Wide Web (web) may publish APIs for use by authorized users. The API database 306 may be configured to include APIs for a variety of content creation tools, such as content creation tools 311-316.

Content creation tool 311 may include any tool for creating text from a prompt, with some examples listed. The list of example content creation tools on the right-hand side of FIG. 3 indicates available services by their tradenames, and it is understood that the list is for example only, and the scope of implementations may be adapted for use with any appropriate content creation tool. Examples of text creation tools may include large language models (LLMs). Content creation tool 312 may include tools that are configured to receive a prompt and in response to the prompt generate an image in a format such as JPEG or other appropriate format, such as by use of a diffusion model. Content creation tool 313 may be configured to generate a video in response to a text prompt, such as by use of a bidirectional masked transformer conditioned on pre-computed text tokens. Examples of video formats that may be used by content creation tool 313 include MP4, MPEG-2, and/or the like. Content creation tool 314 may be configured to generate audio output in response to a text prompt, where examples of audio output formats may include MP4, AAC, and/or the like. Content creation tool 314 may use a neural codec language model or other appropriate model. Content creation tool 315 is configured to generate 3D content in response to a text prompt. Content creation tool 315 may include, e.g., a text to image diffusion model. Content creation tool 315 is configured to generate program code, such as in a variety of programming languages, e.g., Python, C, and the like. Content creation tool 315 may use a large transformer-based language model or other appropriate model.

In the examples of content creation tools 311-316, each of those tools may receive text as a prompt from plug-in service 221. Each of the content creation tools 311-315, having received an appropriate prompt, may output generated content. Furthermore, although specific examples of content creation tools are listed in FIG. 3, it is understood that the scope of implementations is not limited to any particular tools and that the principles described herein may be adapted for use with any appropriate content creation tool.

Application 320 may include any appropriate application, such as a word processor, spreadsheet, drawing application, presentation application, conferencing application, drawing application, web browser, AI-based support application, and/or the like.

In one example use case, a user is using a drawing application as application 320. The user desires to insert visual content into a file that the user is currently editing on a GUI of the IHS. The user may interact with the AI agent 120 via input devices, such as by voice or typing at action 202. The user may request that AI agent 120 performs a task, such as retrieving generated content and pasting the content into the file that the user is editing in application 320. For instance, the user may provide natural language request 308 such as, e.g., “please paste a drawing of a 40-story skyscraper into my drawing file.” The AI agent receives the request 308, applies that natural language input (e.g., to an LLM) and outputs data, such as text data that is configured to be used with API descriptors of the API database 306.

Continuing with the example, the AI agent 120 may be configured to determine a plurality of actions to be taken in response to the natural language input. For instance, the AI agent 120 may be trained to generate a plurality of actions in an order that would generally be expected to satisfy the request. In the present example, the AI agent 120 may generate actions in an order, such as “request image from image content creation tool using prompt [X],” “paste image to drawing application.” In the present example, the order allows for the request and generation of the image before pasting the image, whereas a reversal in the order may not be expected to provide satisfactory results.

Subsequently, the AI agent 120 may be configured to generate text data to correspond to those actions and to the particular order. For instance, the AI agent may generate text output for the plug-in service 221, such as, “text to image” in response to the action, “request image from image content creation tool using prompt [X].” The AI agent 120 may also generate text output for the plug-in service 221, such as “copy,” “clipboard,” “paste,” and “drawing application” in response to the action, “paste image drawing application.”

The plug-in service 221 may then use that text output to search the API database 306 for at least one API associated with image creation tool 312 and use the text output to search the API database 306 for at least one API having a function to paste an image into the drawing application. The plug-in service 221 may use that text output as keys to search the various entries in the API database 306 and return most likely matches. Assuming that the API database 306 finds appropriate matches, then the AI agent 120 may cause the plug-in service 221 to call those APIs in the order of the actions. For instance, the AI agent 120 may cause the plug-in service 221 to call an API for the image content generation tool 312 first in order and, once the content is received from the image content generation tool 312, the AI agent 120 may cause the plug-in service 221 to call an API for the drawing application having a paste function. In one example, the AI agent 120 may provide a text prompt to be used with respect to the API of the image content creation tool 312, where an example prompt may include text such as, “a 40-story skyscraper.”

The result of calling the APIs is that actions are taken, including that the image content generation tool 312 may generate a requested image and return it to the user's IHS, and the pasting API may cause the image to be pasted into a file of the drawing application.

The AI agent 120, once having received confirmation that the API calls have been completed from the plug-in service 221, may provide a report of the action to the user. For instance, the AI agent 120 may display on a GUI of the IHS a text message such as, “a 40-story skyscraper image has been pasted into your drawing application.” The AI agent 120 may also display a text message to the user requesting feedback, such as in the example of FIG. 2.

Of course, various embodiments may include abilities to deal with more complex requests. For instance, while the example request discussed above with respect to FIG. 3 includes the use of two APIs, some requested actions may involve three or more APIs, and AI agent 120 may be trained or otherwise configured to handle such requests. Also, AI agent 120 may be provided with functionality to handle errors, such as when a natural language request does not generate an acceptable match for an API. For instance, the AI agent 120 may provide an error message for the user, request a re-phrase of the natural language request, and/or the like.

Of course, the scope of implementations is not limited to any particular requested tasks or use cases. Rather, various implementations may be adapted for any appropriate task. Examples of tasks may include retrieval of AI-generated content from network-based content creator tools, diagnosing the IHS, configuring the IHS, discovering capabilities of the IHS, troubleshooting the IHS, and investigating and changing security settings of the IHS. Various examples and use cases are provided in Table 1 below. The column “Natural language request” includes natural language text that may correspond to user input, such as in requests 211 and 308. The object application refers to an application that may expose the particular API and, thus, perform a function associated with the API. Examples of object applications may include applications 220, 320, and 311-316. The column “Task completed via APIs” refers to actions taken as a result of API calls.

TABLE 1

| Natural language | | Task completed via |
|---|---|---|
| request | Object application | APIs |
| “I need help with my | AI support or | Launch support or |
| PC” | configuration | configuration |
| “There is something | application | application |
| wrong with my PC” | | |
| “Connect me with | | |
| technical support” | | |
| “Optimize my system | Configuration or | Set thermal tables; |
| to get The best | settings application | run performance |
| performance” | | improvement scripts; |
| | | report changes to |
| | | user |
| “Give me maximum | Configuration or | Set thermal tables; |
| battery life” | settings application | report changes to |
| | | user |
| “Optimize my system | Configuration or | Set thermal tables; |
| to be silent” | settings application | report changes to |
| | | user |
| “I am left-handed” | Peripheral | Configure mouse and |
| “Keep my face | configuring | camera |
| framed” | application | |
| “What can I ask?” | AI support application | Launch support |
| “What does AI | | application; Present |
| support application | | help and phrase |
| do?” | | examples delivered |
| | | in human- |
| | | understandable text |
| “What is the model of | AI support application | Display warranty |
| this device?” | | status to user in |
| “What is the service | | human- |
| tag of this device?” | | understandable text; |
| “How can I renew my | | open browser and go |
| warranty?” | | to webpage to extend |
| | | or renew warranty |
| “Show me the | AI support application | Deliver information to |
| capabilities of this | | user in human- |
| device” | | understandable text |
| “What are the | | |
| technical | | |
| specifications of this | | |
| PC?” | | |
| “In my running the | AI support | Perform at least |
| latest approved | application, third- | some updates; open |
| drivers?” | party vendor website | browser and go to |
| “Does my system | | website for third-party |
| need updates?” | | vendor; use APIs of |
| “Update my PC” | | third-party vendor to |
| | | download and install |
| | | firmware updates |
| “My Internet is slow” | AI support | Run troubleshooting |
| “Improve network | application, | from support |
| speed” | configuration or | application, enable |
| “Improve my browser | settings application | network features in |
| performance” | | configuration or |
| | | settings application, |
| | | run network |
| | | optimization features |
| | | in AI support |
| | | application |
| “How secure is my | Security application | Retrieve security |
| device?” | | data from security |
| “Show me my | | application, display |
| security score” | | results of security |
| | | data retrieval to |
| | | human in human- |
| | | understandable text, |
| | | open security |
| | | application to |
| | | dashboard |
| “I'm in a public | Configuration or | Change privacy |
| space” | settings application | settings to stricter |
| “I am in a private | | configuration in |
| space” | | configuration or |
| “Configure my PC for | | settings application |
| maximum privacy” | | |

Furthermore, while the examples above refer to databases 206 and 306, the scope of implementations may include any appropriate data structure for a listing of APIs and corresponding textual descriptions. For instance, instead of a database, some implementations may use a text file, spreadsheet file, and/or the like.

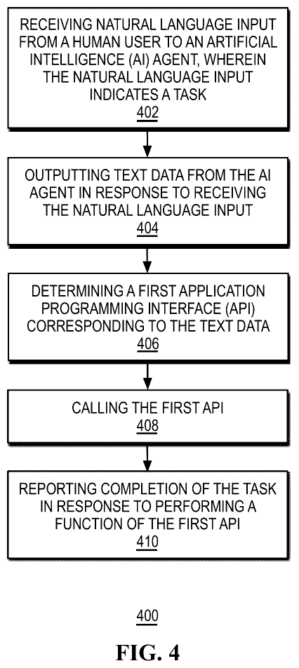

FIG. 4 is an illustration of an example method 400, for selecting one or more APIs through natural language input, according to some implementations. Example method 400 may be performed by an AI agent, such as AI agent 120, which may include a plug-in service 221 and has access to a data structure identifying APIs and corresponding descriptors (e.g., databases 206 and 306). For instance, a processor or processors (e.g., processors 101) may execute computer-readable instructions to perform the functionality associated with AI agent 120, plug-in service 221, and actions 402-410.

At action 402, the AI agent receives natural language input from a human user. The natural language input indicates a task. Examples of tasks may include retrieving and displaying information for the user, retrieving generated content, manipulating generated content within an application, changing hardware and/or software settings, configuring peripherals, and/or the like.

Examples of natural language input include the examples above, and also examples in Table 1 “Natural language request.” For instance, a user may type in a request using a keyboard, may speak into a dictation program, or the like. The natural language input may not necessarily be technical and may even fail to mention particular applications or particular settings levels.

At action 404, the AI agent outputs text data in response to receiving the natural language input. The AI agent may include an LLM or other appropriate AI functionality to generate text output based on the natural language input. Furthermore, the AI agent may be configured so that the text output may generally be expected to be the same as or similar to text that would be included in text-based descriptions of APIs in, e.g., databases 206 and 306. In other words, the AI agent may be trained so that its output is constrained to a universe of text responses that may correspond to text-based descriptions of APIs.

Some examples assume that the database or other data structure has already been established and has a listing of APIs as well as text-based descriptions of those APIs. Various implementations may include re-configuring the AI agent as updates are made to the database so that the AI agent may be expected to comprehensively refer to respective ones of the APIs as appropriate.

At action 406, the AI agent determines a first API corresponding to the text data output. As explained above, the plug-in service 221 may be considered to be part of the AI agent, and the plug-in service 221 may use the text data output to search for and identify appropriate APIs based on the text data output. In one example, the APIs and text descriptions are included in a database, and the plug-in service 221 may use the text data output as a key to search the contents of the entries against the text descriptions. Some implementations may use one to one matching, though other implementations may include intelligence to use approximate matches or best matches. Any appropriate search functionality may be employed to identify corresponding APIs based on the output text data from the AI agent.

Furthermore, action 406 may also include determining a type of content to be generated in response to the natural language input. For instance, in the example of FIG. 3, there may be multiple accessible content creation tools that are available, and the AI agent 120 may be configured to determine a type of content (e.g., text, image, etc.) based on the natural language input. The output text data from the AI agent may be configured to correspond to APIs associated with a content creation tool configured to generate that type of content.

At action 408, the one or more APIs have been identified, and the plug-in service 221 calls the APIs. In some examples, the task may involve multiple actions in a particular order. In such examples, the AI agent may break the task into discrete actions and determine a particular order. The AI agent may then generate the output data at action 404 and identify corresponding APIs at action 406 based on the actions and according to that order.

Action 408 may be described by different terminology, such as “invoking an API,” “making an API request,” “interacting with an application via API” or “triggering an API call.” Calling the APIs at action 408 may cause action to be taken. For instance, calling an API may result in a content generator to generate content based on a prompt, may cause an application to change a setting, may cause an application to acquire telemetry data and display it to the user, may cause a copy or paste action, may launch an application or close an application, and/or the like. In other words, action 408 may include performance of discrete actions that may complete or at least approximate the requested task. The actions taken may correspond to the functions of the one or more APIs.

At action 410, the AI agent may report completion of the task to the user. For instance, the IHS may include a GUI, and the AI agent may display a report of completion using human-understandable text or other output. Action 410 may also include requesting feedback from the human user, receiving feedback from the human user, and applying that feedback to update the AI agent.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method comprising:
receiving natural language input from a human user to an artificial intelligence (AI) agent, wherein the natural language input indicates a task;
outputting text data from the AI agent in response to receiving the natural language input;
determining a first application programming interface (API) corresponding to the text data;
calling the first API; and
reporting completion of the task to the human user in response to performing a function of the first API.

2. The method of claim 1, wherein determining the first API corresponding to the text data comprises:
comparing the text data to a database of APIs, wherein the database of APIs includes text-based descriptions of individual ones of the APIs in the database; and
identifying the first API from the database by searching the text-based descriptions using the text data.

3. The method of claim 2, wherein the database of APIs includes a plurality of APIs specific to an information handling system (IHS) operated by the human user.

4. The method of claim 2, where the database of APIs includes a plurality of APIs specific to a plurality of network-based content creation tools.

5. The method of claim 1, further comprising:
determining a plurality of actions to be taken in response to the natural language input;
determining an order of the plurality of actions to achieve completion of the task;
generating the text data to correspond to the plurality of actions;
determining a plurality of APIs corresponding to the text data, wherein the plurality of APIs includes the first API; and
calling the plurality of APIs in the order of the plurality of actions.

6. The method of claim 1, wherein determining the first API includes determining a type of content to be generated and determining that the first API corresponds to the type of content; wherein the method further includes:
generating the text data to include a prompt to result in creation of the type of content;
including the prompt when calling the first API;
receiving generated content in response to calling the first API; and
applying the generated content to an application.

7. The method of claim 1, wherein outputting the text data includes generating the text data by the AI agent, which includes a large language model (LLM).

8. The method of claim 1, wherein calling the first API results in retrieving telemetry data from an information handling system (IHS) of the human user.

9. The method of claim 1, wherein calling the first API results in changing a setting of an information handling system (IHS) of the human user.

10. The method of claim 1, wherein calling the first API results in configuring hardware or software of an information handling system (IHS) of the human user.

11. The method of claim 1, further comprising:
displaying a request to the human user for feedback as to completion of the task;
receiving feedback from the human user; and
training or configuring the AI agent based on the feedback.

12. An Information Handling System (IHS), comprising:
a processor; and
a memory coupled to the processor, the memory having program instructions stored thereon that, upon execution by the processor, cause the IHS to:
receive a natural language request from a human user to perform a task;
translate the natural language request into output data configured to match with descriptions of a plurality of application programming interfaces (APIs);
determine a first API of the plurality of APIs, according to the output data;
call the first API, thereby causing an action on an IHS of the human user; and
report the action to the human user on a graphical user interface (GUI) of the human user.

13. The IHS of claim 12, wherein the program instructions to cause the IHS to translate the natural language request into output data includes program instructions to cause the IHS to: generate text data in response to the natural language request.

14. The IHS of claim 12, wherein the program instructions to cause the IHS to determine a first API includes program instructions to cause the IHS to: search a database of the plurality of APIs and corresponding text-based descriptors of the APIs, including comparing the output data to the text-based descriptors, and select the first API from the plurality of APIs based on a best match between the text-based descriptors and the output data.

15. The IHS of claim 12, wherein the program instructions to cause the IHS to call the first API includes program instructions to cause the IHS to: call the API over a network, wherein the API corresponds to a function performed by a network-based content creation tool.

16. The IHS of claim 12, wherein the program instructions to cause the IHS to call the first API includes program instructions to cause the IHS to: request a settings or configuration application to change a hardware or software setting of the IHS.

17. A hardware memory device having program instructions stored thereon that, upon execution by a processor of an Information Handling System (IHS), cause the IHS to:
receive a natural language request from a human user to perform a task;
translate the natural language request into text data that is configured to match with descriptions of a plurality of application programming interfaces (APIs) of a database of APIs;
search the database, according to the text data, to determine a first API of the plurality of APIs;
call the first API, thereby causing an action on an IHS of the human user; and
report the action to the human user.

18. The hardware memory device of claim 17, further comprising program instructions to cause the IHS to:
request feedback from the human user as to performance of the task;
receive the feedback from the human user; and
train or configure an artificial intelligence agent, associated with translating the natural language request into the text data, based on the feedback.

19. The hardware memory device of claim 17, wherein the program instructions to cause the IHS to translate the natural language request into the text data includes program instructions to cause the IHS to: apply the natural language request to a large language model.

20. The hardware memory device of claim 17, wherein the program instructions to cause the IHS to search the database to determine the first API includes program instructions to cause the IHS to: determine a second API in addition to the first API for performing the task.
